(19) United States
(12) Patent Application Publication
(10) Pub. No.: US 2017/0208023 A1
(43) Pub. Date: Jul. 20, 2017

(54) FILE OPERATION CHECK APPARATUS, COMPUTER-READABLE STORAGE MEDIUM HAVING FILE OPERATION CHECK PROGRAM STORED THEREIN, AND METHOD OF CHECKING FILE OPERATION

(71) Applicant: FUJITSU LIMITED, Kawasaki-shi (JP)

(72) Inventors: Yoshinori Katayama, Kawasaki (JP); Takeaki Terada, Kawasaki (JP); Satoru Torii, Yokohama (JP); Hiroshi Tsuda, Fujisawa (JP)

(73) Assignee: FUJITSU LIMITED, Kawasaki-shi (JP)

(21) Appl. No.: 15/405,543

(22) Filed: Jan. 13, 2017

(30) Foreign Application Priority Data
Jan. 14, 2016 (JP) 2016-005311

(51) Int. Cl. H04L 12/58; G06F 3/14; G06F 3/0482; G08B 5/22; H04L 29/08

(52) U.S. Cl. CPC H04L 51/063; G08B 5/22; H04L 51/08; H04L 67/06; G06F 3/0482; G06F 3/14; G06F 3/0485

(57) ABSTRACT

Provided are a memory, and a processor coupled to the memory. The processor is configured to detect a size of a display area for displaying respective selection areas associated with a plurality of selection candidate files that are selectable as an operation-target file, and a total display size of the selection areas for the selection candidate files displayed on the display area, and output an alert for prompting a confirmation of the file selected as the operation-target file, when a ratio of the total display size to the size of the display area exceeds a threshold.

### CROSS-REFERENCE TO RELATED APPLICATION

This application is based upon and claims the benefit of priority of the prior Japanese Patent Application No. 2016-005311, filed on Jan. 14, 2016, the entire contents of which are incorporated herein by reference.

### FIELD

The present invention relates to a file operation check apparatus, a computer-readable storage medium having a file operation check program stored therein, and a method of checking a file operation.

### BACKGROUND

One of the causes of an incident of information leakage is erroneous mail transmissions. In order to reduce such information leakage risk caused by erroneous mail transmissions, a wide variety countermeasure have been taken.

For example, for erroneous mail transmissions caused by sending them to wrong destinations, countermeasures are known, wherein an application issues a warning in response to a transmission of a mail to an external organization.

Attaching wrong files is also another cause of erroneous mail transmissions. Examples include attaching obsolete files to mails by mistake, or attaching a file for a different company to a mail by mistake, for example. One countermeasure against erroneous mail transmissions caused by attachments of wrong files is to issue an alarm from an application, when there are a lot of files that can be selected (selectable files) as an attachment.

Patent Document 1: Japanese Laid-open Patent Publication No. 2010-160613

Patent Document 2: Japanese Laid-open Patent Publication No. 2008-20979

Patent Document 3: Japanese Laid-open Patent Publication No. 2004-362057

Mix-up errors of attachment files, however, are caused by factors other than the number of selectable files. Accordingly, even when an alarm is issued depending on the number of selectable files, preventing a mix-up error of an attachment file may be difficult.

Besides an operation to attach a file to a mail, file mix-up errors may also occur during other file operations, such as save, copy, and backup processing of files.

### SUMMARY

According to an aspect of the embodiments, a file operation check apparatus includes a memory, and a processor coupled to the memory. The processor is configured to detect a size of a display area for displaying respective selection areas associated with a plurality of selection candidate files that are selectable as an operation-target file, and a total display size of the selection areas for the selection candidate files displayed on the display area, and output an alert for prompting a confirmation of the file selected as the operation-target file, when a ratio of the total display size to the size of the display area exceeds a threshold.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1A is a diagram illustrating one example of a technique to determine a file mix-up risk where icons are arranged and displayed in two rows;

FIG. 1B is a diagram illustrating one example of a technique to determine a file mix-up risk where nearly half of a screen is filled with icons;

FIG. 2 is a block diagram illustrating an example of a configuration of a system according to one embodiment;

FIG. 3 is a block diagram illustrating an example of a hardware configuration of a computer according to one embodiment;

FIG. 4 is a block diagram illustrating an example of a configuration of the computer according to one embodiment;

FIG. 5 is a diagram illustrating an example of the screen transitions of a mail client;

FIG. 6A is a diagram illustrating an example of an available display area where the available display area is a desktop;

FIG. 6B is a diagram illustrating an example of an available display area where the available display area is a folder;

FIG. 7A is a diagram illustrating an example of a file view format where the file view format is an icon view format;

FIG. 7B is a diagram illustrating an example of a file view format where the file view format is a list view format;

FIG. 7C is a diagram illustrating an example of a file view format where the file view format is a detailed view format;

FIG. 8 is a block diagram illustrating an example of a functional configuration of the computer according to one embodiment;

FIG. 9 is a diagram illustrating an example of a data structure of a system information DB;

FIG. 10 is a diagram illustrating an example of a data structure of a file operation log;

FIG. 11 is a diagram illustrating an example of a data structure of an attachment alert policy;

FIG. 12 is a diagram illustrating an example of the file mix-up ratio when an operation focus area is a desktop;

FIG. 13 is a diagram illustrating an example of the file mix-up ratio when an operation focus area is a window;

FIG. 14 is a diagram illustrating an example of the file mix-up ratio when an available display area is scrollable;

FIG. 15 is a diagram illustrating an example of the file mix-up ratio when an available display area is scrollable;

FIG. 16 is a diagram illustrating an example of the file mix-up ratio in accordance with attachment operation time durations;

FIG. 17 is a diagram illustrating one example of an attachment alert screen;

FIG. 18 is a diagram illustrating one example of the attachment alert screen;

FIG. 19 is a diagram illustrating one example of the attachment alert screen;

FIG. 20 is a diagram illustrating one example of a save alert screen;

FIG. 21 is a flowchart illustrating an example of operations of the computer according to one embodiment;

FIG. 22 is a flowchart illustrating the example of operations of the computer according to one embodiment;

FIG. 23 is a diagram illustrating one example of incident countermeasure levels; and

FIG. 24 is a diagram illustrating one example of security countermeasures.

### DESCRIPTION OF EMBODIMENTS

Hereinafter, an embodiment of the present invention will be described with reference to the drawings. The embodiment described below, however, is by way of example and it is not intended to exclude various modifications and applications of techniques that are not explicitly illustrated in the embodiment. For example, the present embodiment can be practiced by making various modifications without departing from the spirit thereof. In the drawings of the embodiment described below, elements having like reference symbols denote the same or similar elements, unless otherwise stated.

### (1) One Embodiment

Hereinafter, descriptions will be made, focusing on an attachment of a file to a mail as a scenario where a file mix-up error occurs.

It is difficult for a sender of a mail to notice an attachment of a wrong file upon a transmission of the mail only by making a confirmation by the sender. For example, when the sender makes operations other than the attachment and then makes the confirmation or check, the sender may possibly be preoccupied with different tasks and the effectiveness of the confirmation aimed at reducing a human error may be reduced.

In other words, human errors can be reduced if the sender makes a confirmation or check of an attachment file when selecting or attaching the attachment file in relation to the operations to select or attach an attachment file, for example, besides making a confirmation upon sending a mail.

In one embodiment, for example upon a transmission of a mail, the destination may be confirmed and the title and the file name, and the like may be confirmed or check, for example. During a file selection operation, the items that may possibly be selected by mistake maybe confirmed or checked, independently from the check upon a transmission of the mail, for example. This can reduce the risk of an erroneous file selection operation.

Here, although the number of selectable files can affect mix-up errors of attachment files, an analysis on actual operations on attachment files has revealed that such errors may also be induced by factors other than the number of selectable files.

As one example, depending on some view formats or the display area of files selectable as an attachment file, all or apart of the file names of the selectable files are not displayed. In this case, a sender may possibly attach a wrong file that has a name similar to the name of a correct attachment file, e.g., a file of a different revision.

To address this issue, one embodiment reduces the risk of a file mix-up with the following techniques:

For example, a file operation check apparatus may detect a size of a display area for displaying respective selection areas associated with a plurality of selection candidate files that are selectable as an operation-target file, and a total display size of the selection areas for the selection candidate files displayed on the display area. The file operation check apparatus then may output an alert for prompting a confirmation of the file selected as the operation-target file from the plurality of selection candidate files, when a ratio of the total display size to the size of the display area exceeds a threshold.

For example, the file operation check apparatus may output the alert, in response to attachment processing of a file to a mail, in place of or in addition to in response to a transmission of a mail. Therefore, in accordance with the file operation check apparatus, since a sender of the mail can make a detailed confirmation in response to the location of the attachment target file, e.g., a status of a desktop or a folder, the risk of an attachment file mix-up can be reduced.

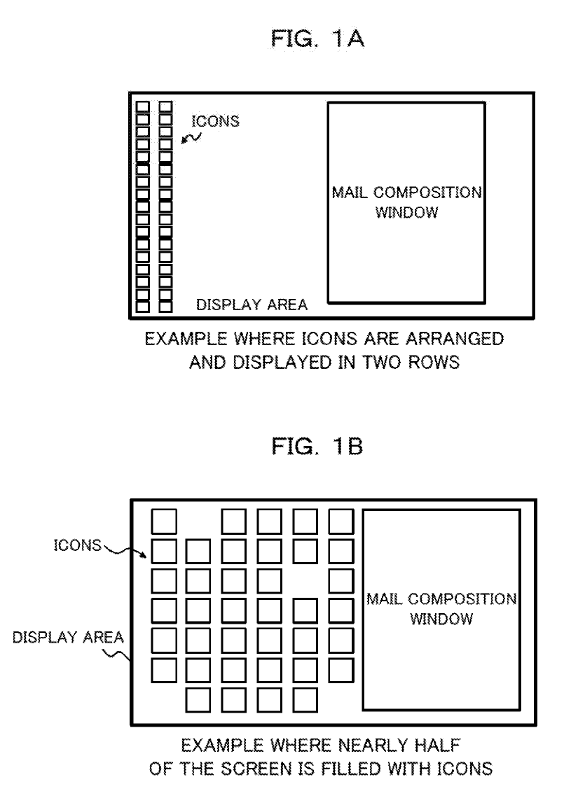

As exemplified in FIGS. 1A and 1B, the size of the display area and the total display size of the selection areas for the selection candidate files displayed on the display area may be determined based on the screen resolution and the size of icons depending on the view format. Note that the examples of FIGS. 1A and 1B are examples wherein the display area is the desktop. Note that the display area may be an area in which multiple files can be displayed, and may be referred to as the “available display area”.

In the example of FIG. 1A, since the screen resolution is high, all of the 34 icons are displayed in two rows in the display area of the display. For example, when the threshold is 50%, the ratio of the display size of the icons to the size of the display area is less than that threshold and thus the risk of a file mix-up is considered to be low.

Therefore, in the example of FIG. 1A, when an operation-target file is selected, the file operation check apparatus may stop displaying an alert for prompting to confirm a file as correct one. In other words, annoying notifications can be prevented.

On the contrary, in the example of FIG. 1B, since the screen resolution is low, the areas of the 38 icons occupy more than the half of the display area and some icons may possibly be hidden behind a mail composition window. For example, when the threshold is 50%, the ratio of the display size of the icons to the size of the display area exceeds that threshold and thus the risk of a file mix-up is considered to be high.

Accordingly, in the example of FIG. 1B, when an operation-target file is selected, the file operation check apparatus may display an alert for prompting to confirm a file as correct one.

As described above, in accordance with the file operation check apparatus according to one embodiment, since intrinsic causes of a file mix-up can be addressed depending on the status where a file is selected, it is possible to provide users with functions to directly reduce human errors. As a result, the risk of a file mix-up can be reduced.

Hereinafter, an example wherein the risk of a mix-up error of an attachment file to a mail is reduced will be described as one embodiment. Note that an example of operations according to one embodiment are also applicable to other file operations, such as save, copy, or backup processing of files.

(1-1) Example of Configuration of System According to One Embodiment

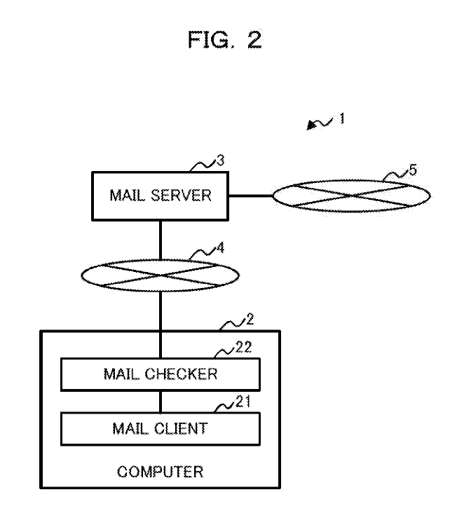

FIG. 2 is a block diagram illustrating an example of a configuration of a system 1 according to one embodiment. As depicted in FIG. 2, the system 1 may include a computer 2, a mail server 3, and networks 4 and 5, as an example. Note that multiple computers 2 may also be present in the system 1.

The computer 2 represent one example of a file operation check apparatus that selects an operation-target file, from multiple selection candidate files (selectable files). Examples of the computer 2 include a wide variety of information processing apparatuses, such as a personal computer (PC), a server, a smartphone, or a tablet, for example.

The computer 2 may include a mail client 21 and a mail checker 22, as an example. The mail client 21 represents one example of software for composing, sending, and receiving mails, for example. The mail checker 22 represents one example of software that issues a wide variety of alerts or the like, in response to an action by a user on the mail client 21, for preventing erroneous mail transmissions. Note that functions of the mail checker 22 may be incorporated in the mail client 21. The mail client 21 and the mail checker 22 will be described later.

The mail server 3 represents one example of an information processing apparatus that controls transmissions and receptions of mails to and from the computer 2. For example, the mail server 3 may send mails sent from the mail client 21 in the computer 2, to the network 5, or deliver mails addressed to the mail client 21, to the computer 2.

The network 4 represents one example of a communication network that communicably connects the computer 2 and the mail server 3, via a cable, or wirelessly, or a combination thereof. Examples of the network 4 include a local area network (LAN) or a wide area network (WAN), for example.

The network 5 represents one example of a communication network that communicably connects the mail server 3 and a mail destination (not illustrated), via a cable, or wirelessly, or a combination thereof. An example of the network 5 is the Internet, for example.

Note that the computer 2, the mail server 3, and the network 4 may configure an intranet, such as intra-company network or a home network, for example. The network 4 may also be a virtual dedicated line, such as a dedicated line or a virtual private network (VPN).

Further, when the computer 2 utilizes a mail function provided by a cloud service, at least a part of the network 4 maybe the Internet. In this case, at least a part of the respective functions of the mail client 21 and the mail checker 22 provided at the computer 2 may be provided by a server that provides the cloud service, such as the mail server 3, for example. Note that the function of the mail client 21 and the function of the mail checker 22 are separately distributed in the mail server 3 and the computer 2.

When the mail server 3 has the functions of the mail client 21 and the mail checker 22, the computer 2 may access the mail function provided by the mail server 3 via a program, e.g., a Web browser, for example, and the mail server 3 may output an alert from the mail checker 22, to the Web browser on the computer 2.

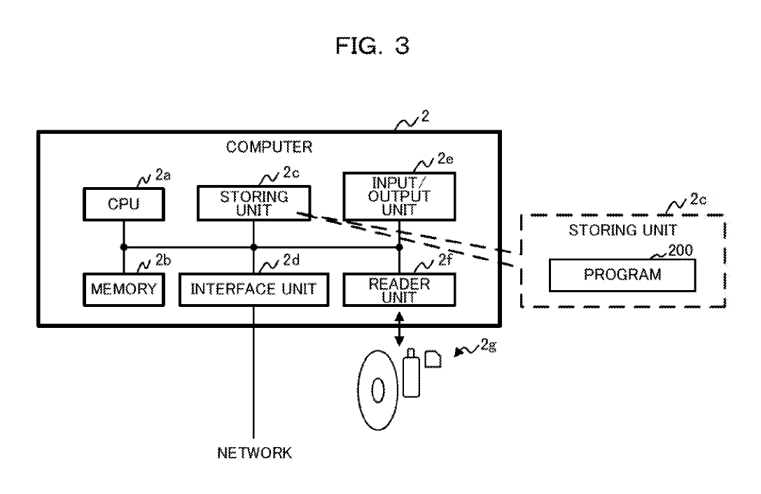

Next, an example of the hardware configuration of the computer 2 will be described. Note that the mail server 3 may also have a hardware configuration similar to that of the computer 2, for example. As depicted in FIG. 3, the computer 2 may include a central processing unit (CPU) 2a, a memory 2b, a storing unit 2c, an interface unit 2d, an input/output unit 2e, and a reader unit 2f, as an example.

The CPU 2a represents one example of a processor that carries out a wide variety of controls and computations. The CPU 2a may be communicatively connected to each block in the computer 2 through buses. Instead of the computing processing unit, e.g., the CPU 2a, an electric circuit may also be used as a processor, such as integrated circuits (IC), e.g., a micro processing unit (MPU), an application specific integrated circuit (ASIC), a field programmable gate array (FPGA).

The memory 2b represents one example of hardware that stores information, such as a various types of data and programs. An examples of the memory 2b includes a volatile memory, such as a random access memory (RAM), for example.

The storing unit 2c represents one example of hardware that stores information, such as a various types of data and programs. Examples of the storing unit 2c include various storage devices, such as a magnetic disk apparatus, e.g., a hard disk drive (HDD); a semiconductor drive device, e.g., a solid state drive (SSD); and non-volatile memories, e.g., a flush memory and a read only memory (ROM), for example.

For example, the storing unit 2c may store a program 200 that embodies all or apart of various functions of the computer 2. The program 200 may include a file operation check program that embodies the functions of a file operation check apparatus according to one embodiment. The CPU 2a can embody the functions of the computer 2 by loading the program 200 stored in the storing unit 2c into the memory 2b and executing it, for example. When at least a part of the function of the mail checker 22 is embodied by the mail server 3, the program 200 may be provided at both the computer 2 and the mail server 3, or the program 200 may be divided and the divided functions may be provided at both the computer 2 and the mail server 3, where appropriate.

The interface unit 2d represents one example of a communication interface that controls connections and communications to the network 4 and the like. For example, an example of the interface unit 2d includes an adaptor compliant with standards, such as a LAN, a Universal Serial Bus (USB), or Bluetooth®.

Note that the program 200 may be download from the network 4 or the like to the computer 2, via the interface unit 2d.

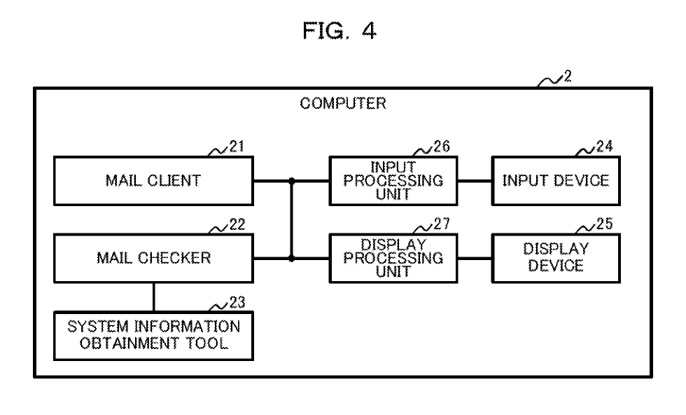

The input/output unit 2e may include at least some input units, such as a mouse, a keyboard, and an operation button (e.g., an input device 24 in FIG. 4), and an output unit, such as a display and a printer (e.g., a display device 25 in FIG. 4). For example, the input unit may be used for various operations by users, such as a composition of a mail, a selection of an attachment file, a transmission and reception of mails, and input of selection parameters. The output unit may be used for a display in response to the various operations on the computer 2.

The reader unit 2f represents one example of a reader that reads information of data and programs stored in a storage medium 2g. The reader unit 2f may include a connection terminal or a device, to which the computer-readable storage medium 2g can be connected or inserted. Examples of the reader unit 2f include an adaptor compliant with standards, e.g., USB; a drive device for accessing to storage disks; and a card reader for accessing to flush memories, e.g., SD cards, for example. Note that the storage medium 2g may have a program 200 stored therein.

Example of the storage medium 2g include non-transitory storage media, such as flexible disks; optical disks, e.g., CDs, DVDs, and a Blu Ray® disc; and flush memories, e.g., USB memories and SD cards, for example. Examples of CDs include CD-ROMs, CD-Rs, and CD-RWs, for example. Examples of DVDs include DVD-ROMs, DVD-RAMS, DVD-Rs, DVD-RWs, DVD+Rs, and DVD+RWs, for example.

The above-described hardware configuration of the computer 2 is merely exemplary. Hence, any hardware maybe added or omitted (e.g., adding or omitting any blocks), or maybe divided, or may be combined in any combinations, or any buses maybe added or omitted, in the computer 2, where appropriate, for example.

(1-2) Example of Configuration of Computer

Next, an example of the configuration of the computer 2 according to one embodiment will be described. Descriptions will be made in the context of an example wherein the computer 2 has the functions of the mail client 21 and the mail checker 22. When the computer 2 utilizes mail functions provided by a cloud service, the term “the computer 2” may be replaced with “the mail server 3” where appropriate.

For the functions of mail operations, as depicted in FIG. 4, the computer 2 may include the mail client 21, the mail checker 22, a system information obtainment tool 23, an input device 24, a display device 25, an input processing unit 26, and a display processing unit 27, as an example.

The mail client 21 is an application that enables various types operations on mails, such as compositions, transmissions, receptions, and browsing of mails. While a mail is composed, a file may be attached. In place of “file”, the term “content” may also be used.

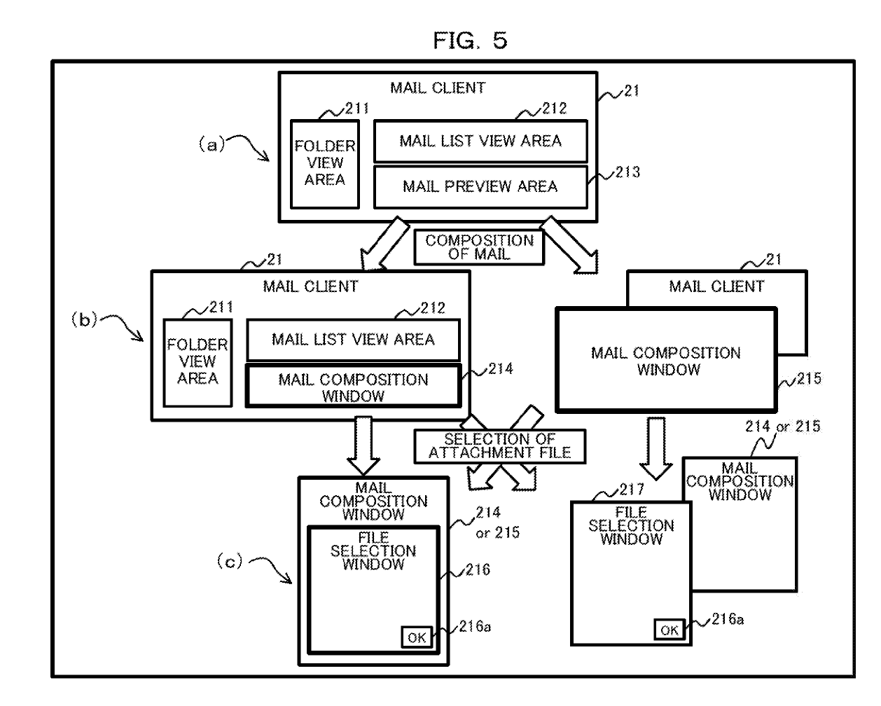

As indicated by a reference sign (a) in FIG. 5, the mail client 21 may include a folder view area 211 that displays mails hierarchically in folders, a mail list view area 212 that displays a list of mails, and a mail preview area 213, in the window, as an example. The mail preview area 213 may display a preview of a mail selected in the mail list view area 212.

For composing a mail in the mail client 21, a mail composition window 214 or 215 may be displayed, as indicated by a reference sign (b) in FIG. 5. For example, the mail composition window 214 may be displayed within the mail preview area 213 (refer to the left side of (b) in FIG. 5), or a window of the mail composition window 215 may be displayed as a window separate from the mail client 21 (refer to the right side of (b) in FIG. 5).

Note that the term “a composition of a mail” may include composition of a new mail, replying or transfer of a mail, and editing of a draft mail, and other operations on mails.

For attaching a file to a mail, a file selection window 216 or 217 may be displayed, as indicated by a reference sign (c) in FIG. 5. For example, the file selection window 216 may be displayed within a region in the mail composition window 214 or 215 (refer to the left side of (c) in FIG. 5). Alternatively, a window of the file selection window 217 may be displayed as a window separate from the mail composition window 214 or 215 (refer to the right side of (c) in FIG. 5). When an OK button 216a is depressed while a file is selected in the file selection window 216 or 217, the selected file may be attached in the mail composition window 214 or 215, for example.

Here, methods of attaching a file to a mail can be classified into the following methods, as an example:
A drug method in which a file is drugged from the desktop or a folder window and dropped into a window containing the mail composition window 214 or 215, for attaching the file.
A selection operation method in which a selection operation of a file is initiated in the mail composition window 214 or 215, and a file is selected in the file selection window 216 or 217 for making selection operations.

Note that a file may be attached to a mail with a copy-and-paste, instead of a drug-and-drop in the drug method. The drug or copy allows selection of multiple files. Alternatively, a file may be selected by navigating through the hierarchy of folders in the file selection window 216 or 217 for making selection operations in the selection operation method.

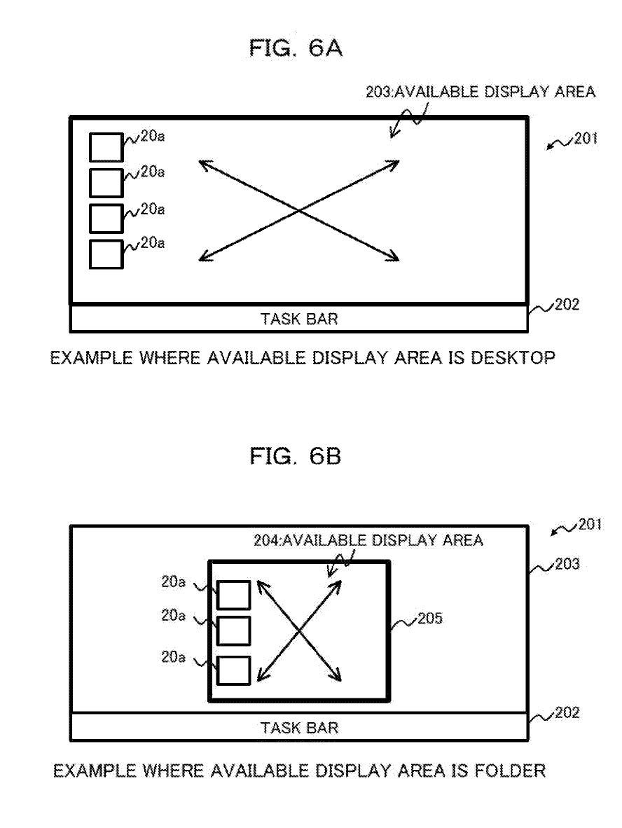

Next, an available display area will be described which is a region where candidate files to be selected (selection-target files) are displayed. The available display area represents one example of a display area that displays respective selection areas associated with multiple selection candidate files which can be selected as a selection-target file. The available display area may be able to display multiple selection candidate files in a list format, for example, and examples of such available display areas are areas 203 and 204 illustrated in FIGS. 6A and 6B, respectively, as an example.

As depicted in FIG. 6A, the desktop 201 may include a task bar 202 and the available display area 203, as an example. For example, when multiple selection candidate files are present on the desktop 201, a selection-target file may be drugged from the available display area 203 and dropped into the mail composition window 214 or 215 in the drug method. Note that the task bar 202 may display various types of information, such as information about applications being executed on the computer 2, in a list format, and the available display area 203 may display icons 20a of files or folders in a list format. Note that the available display area 203 may contain a display area of the task bar 202.

A window of folders being browsed or a window of an application being executed may also be displayed in the available display area 203. For example, when multiple selection candidate files are present in a folder, an area of the window 205 where files or folders in that folder can be displayed, as depicted in FIG. 6B, may be referred to as the “available display area 204”. Note that the folder window may contain a folder for storing downloaded files and a document folder for saving created documents. The term “directory” may be used instead of “folder”.

When the available display area 204 is a folder window, a selection-target file maybe drugged from the available display area 204 and dropped into the mail composition window 214 or 215 in the drug method. Alternatively, when the available display area 204 is an application window, such as the file selection window 216 or 217 of the mail client 21, for example, a selection-target file may be selected from the available display area 204 in the selection operation method.

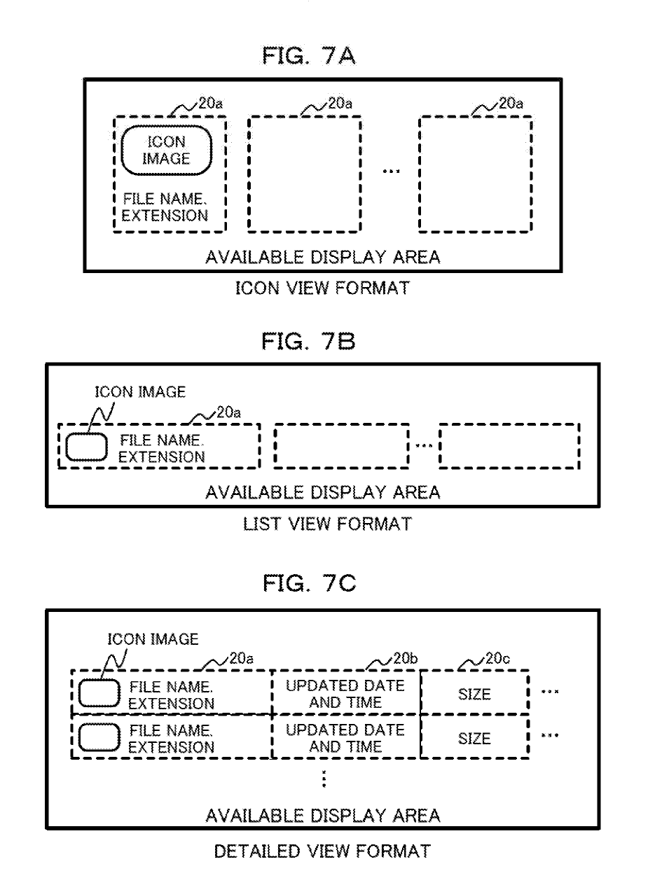

In the following descriptions, selection areas of files in the available display area 203 or 204 may be referred to as icons 20a, and the view format of the selection areas in the available display area 203 or 204 may be referred to as icon formats, for the sake of brevity. As exemplified in FIGS. 7A, 7B and 7C, the icon formats may include various types, such as an icon view format (refer to FIG. 7A), a list view format (refer to FIG. 7B), and a detailed view format (refer to FIG. 7C).

The icon view format and the list view format are view formats that display icons 20a in a predetermined size including icon images of files and file names, for example. Hereinafter, the view format that arranges the icon image and the file name of the icon 20a in a horizontal row is referred to as the “list view format”, for the sake of brevity of descriptions. The detailed view format is the view format in which icons 20a in a predetermined size including icon images of files and file names are displayed, together with detailed information, such as updated date and time 20b and sizes 20c of the files, for example.

Note that the icon images in the icons 20a may be images of icons or thumbnails of files corresponding to file types, such as file extensions, for example. Either or both of the icons 20a in the list view format and the detailed view format may not have icon images.

The screen transitions, the available display areas, and the file view formats of the mail client 21 are not limited to those in the above-described example, and a wide variety of modifications may be applied.

Referring back to FIG. 4, the mail checker 22 is an application that monitors actions by a user on the mail client 21, i.e., operations of the mail client 21, and displays alerts in accordance with the operations of the mail client 21. For example, the mail checker 22 may display alerts, in response to at least one of operations of a composition of a mail, selection of a file, an attachment of a file to a mail, and transmissions and receptions of mails.

The system information obtainment tool 23 represents one example of software that obtains system information of the computer 2. An example of operations of the system information obtainment tool 23 will be described later. Note that the functions of the system information obtainment tool 23 may be incorporated in the mail checker 22.

The mail client 21, the mail checker 22, and the system information obtainment tool 23 may be provided as applications executed on an operating system (OS) that runs on the computer 2.

The input device 24 and the display device 25 represent examples of the input/output unit 2e, respectively, illustrated in FIG. 3. The input device 24 may be a device, such as a mouse and a keyboard, for example. The display device 25 may be a monitor, such as a liquid crystal display (LCD), for example.

The input processing unit 26 and the display processing unit 27 represent examples of drivers, each of which are embodied by a part of the functions of the OS or operates on the OS. The input processing unit 26 may output information entered through the input device 24, to the mail client 21 or the mail checker 22, or may output the entered information to the display processing unit 27, for displaying it on the display device 25. The display processing unit 27 may perform a display processing on the display device 25, based on the entered information.

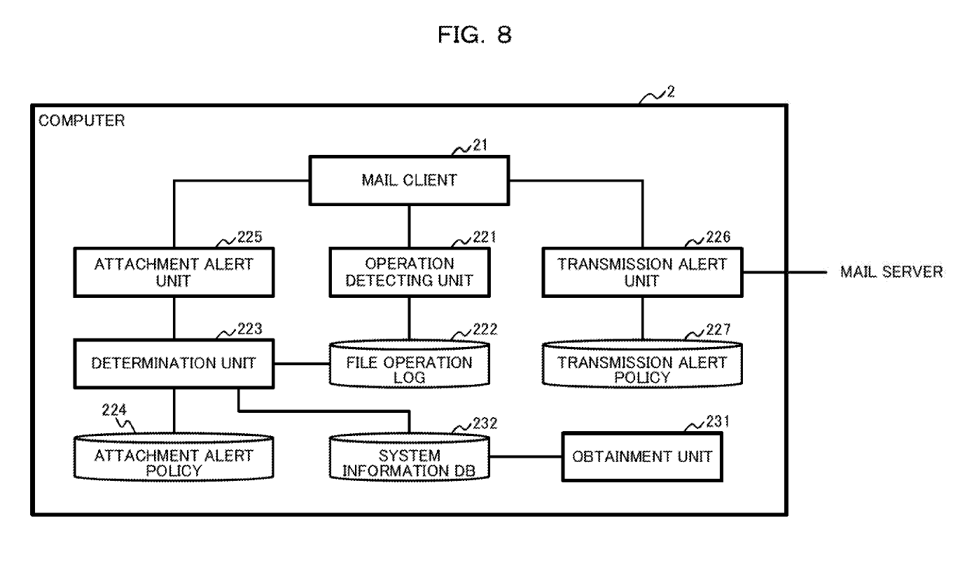

Next, referring to FIG. 8, examples of the configurations of the mail client 21, the mail checker 22, and the system information obtainment tool 23 will be described. As depicted in FIG. 8, the computer 2 may include the mail client 21, an obtainment unit 231, and a system information database (DB) 232, as an example. The obtainment unit 231 and the system information DB 232 may be functions provided in the system information obtainment tool 23.

The computer 2 may also include an operation detecting unit 221, a file operation log 222, a determination unit 223, an attachment alert policy 224, an attachment alert unit 225, a transmission alert unit 226, and a transmission alert policy 227, as functions of the mail checker 22, as an example.

At least one of the file operation log 222, the attachment alert policy 224, the transmission alert policy 227, and the system information DB 232 may be embodied by storage areas in the memory 2b or the storing unit 2c depicted in FIG. 3.

The obtainment unit 231 obtains the system information of the computer 2, and stores the obtained system information in the system information DB 232. The system information may be obtained at any timing or during any time duration, such as upon a startup of the computer 2 or the mail client 21, during an operation of the computer 2 or the mail client 21, during a composition of an outgoing mail, and during an attachment operation of a file, for example.

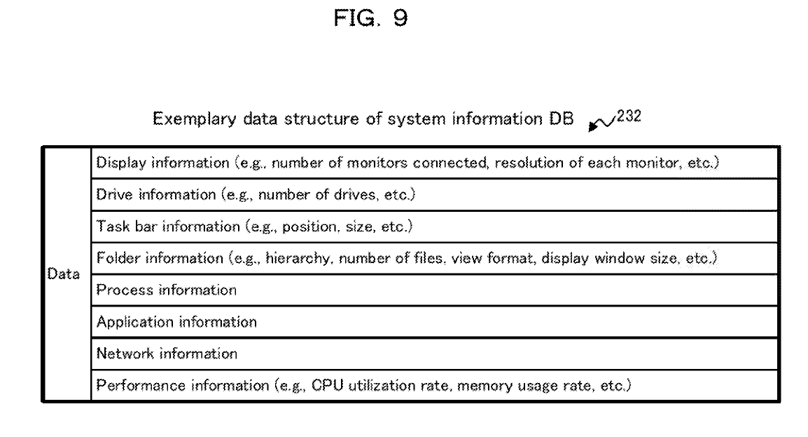

The system information DB 232 represents one example of a database that stores the system information obtained by the obtainment unit 231. An example of the data structure of the system information DB 232 is illustrated in FIG. 9.

As exemplified in FIG. 9, the system information obtained by the obtainment unit 231 may include information on processes and information on applications, as well as basic information of the system. The basic information of the system may include display information, information on the respective drives, task bar information, and folder information.

Note that the display information includes the number of the display devices 25 (they may also be referred to as “monitors” hereinafter) connected to the computer 2, and the respective resolutions of the monitors. The information on the drives includes information, such as the number of storing units 2c connected to the computer 2. The task bar information includes information, such as the position and the size of the task bar on the desktop. The folder information includes the hierarchy of folders in the storing unit 2c in the computer 2, the number of files present in each folder, the view format of icons 20a for each folder, the display window size of the folders, and the like.

The obtainment unit 231 may also obtain a wide variety of performance information, such as the status of the network, the utilization rate of the CPU 2a, and the usage rate of the memory 2b, while the computer 2 runs or the mail client 21 is executed.

The obtainment unit 231 may further obtain the latest information on a folder from which a selection operation of a file is to be made, and that file, where appropriate, in response to an operation for a composition of an outgoing mail or an attachment of a file.

Besides the information described above, the system information may also include information on colors of the desktops, folders, and files (e.g., the icons 20a).

The operation detecting unit 221 detects processing related to a file operation, and records a log of that file operation into the file operation log 222. The processing related to file operations may be detected in response to operations of the mouse and the keyboard, for example. Processing by the operation detecting unit 221 maybe executed when an outgoing mail is composed or when an operation on an attachment file is made, for example. Note that operations on attachment files include selections of files and attachments of files to mails.

In the meantime, attachments of files to outgoing mails can be classified into two categories: an attachment of a file present on the desktop 201 and an attachment of a file present on a window 205 of a certain folder. Therefore, the operation detecting unit 221 may detect whether an attachment file is present on the desktop 201 or the window 205, in other words, whether the file has been selected from the available display area 203 or 204.

The operation detecting unit 221 may also detect whether an attachment file has been selected with the drug method or the selection operation method.

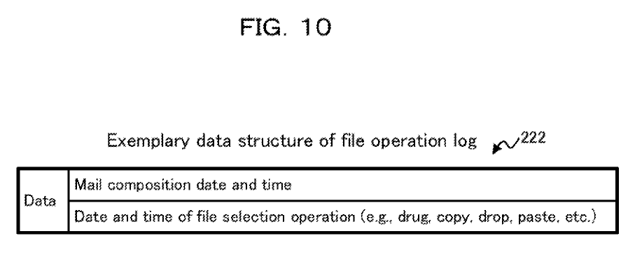

The file operation log 222 represents one example of a database that stores information of the file operation log obtained by the operation detecting unit 221. An example of the data structure of the file operation log 222 is illustrated in FIG. 10.

As exemplified in FIG. 10, the file operation log obtained by the operation detecting unit 221 may include information on date and time when mails were composed, and information on date and time when operations related to file selections were made. The operations related to file selections may include operations of drug, copy, drop, paste, and the like, of files, for example.

The determination unit 223 determines whether to issue a confirmation alert, in response to a file selection operation, based on the file operation log 222, the system information DB 232, and the attachment alert policy 224.

The attachment alert policy 224 represents one example of a database that stores information on a threshold used for making a determination whether to issue a confirmation alert by the determination unit 223.

The attachment alert unit 225 displays a confirmation of an attachment file to a user, based on the result of the determination made by the determination unit 223. Note that confirmation display processing by the attachment alert unit 225 may include obtaining information on a target folder from which the file is to be selected and the files in the target folder, and generating a screen of a confirmation view.

An example of operations of the determination unit 223 and the attachment alert unit 225, and an example of the data structure of the attachment alert policy 224 will be described later.

In response to a transmission of a mail from the mail client 21, the transmission alert unit 226 makes a determination about that mail based on the transmission alert policy 227, and displays a confirmation alert in accordance with the result of the determination. In this case, the transmission alert unit 226 may suspend the transmission of the mail to the mail server 3, such as by preserving the mail in a queue, for example, and may transfer the mail to the mail server 3 after the user makes a confirmation.

Note that the confirmation display processing by the transmission alert unit 226 may include determining whether or not the contents of a mail (e.g., the destination, the subject, or the body) or an attachment file, or the like violates the transmission alert policy 227, and displays a confirmation alert processing when there is any violation, for example.

The transmission alert policy 227 represents one example of a database that stores policies for contents of mails (e.g., destinations, subjects, or bodies), and attachment files, and the like. The transmission alert unit 226 and the transmission alert policy 227 can be embodied using a wide variety of well-known techniques.

As set forth above, the operation detecting unit 221, the file operation log 222, the determination unit 223, the attachment alert policy 224, and the attachment alert unit 225 represent one example of an attachment file checker that displays an alert in response to an attachment of a file to a mail. The transmission alert unit 226 and the transmission alert policy 227 represent one example of an outgoing mail checker that displays an alert in response to a transmission of a mail. The attachment file checker may be provided as an extension function of the outgoing mail checker in the mail checker 22.

(1-3) Description of Determination Unit

Next, an example of operations of the determination unit 223 will be described. The determination processing by the determination unit 223 may include processing of obtaining operation information related to a file selection and processing of comparing the operation information with a threshold.

The processing of obtaining operation information will be described first. An example of the operation information includes the total occupation ratio of the multiple icons 20a displayed in the available display area 203 or 204, to the available display area 203 or 204 displaying multiple selection candidate files, for example. Note that the total occupation ratio of the multiple icons 20a represents one example of a ratio of the total display size of the multiple icons 20a, to the size of the available display area 203 or 204.

As one example, the determination unit 223 may obtain the resolution of the monitor, and the resolution of the selection area per file (e.g., the resolution for a single icon 20a), from the system information DB 232. The determination unit 223 may then calculate the area of the available display area 203 or 204, and the area of a single icon 20a, based on those resolutions. The determination unit 223 may then obtain the total area of the multiple icons 20a, by multiplying the number of icons 20a displayed in the available display area 203 or 204 with the area of a single icon 20a. In such a manner, the determination unit 223 can calculate the total occupation ratio of the multiple icons 20a to the available display area 203 or 204.

Note that the resolution per a single icon 20a may also be obtained based on the view format of icons, for example. In the case of the available display area 204 inside a window, the area of the available display area 204 may be obtained based on the display window size of folders stored in the system information DB 232.

The determination unit 223 may calculate information other than the occupation ratio, as the operation information. Another example of the operation information will be described in an example of operations described later.

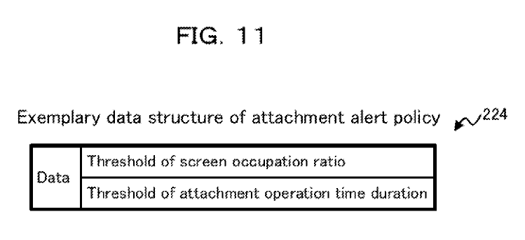

Next, the processing of comparing the operation information with a threshold will be described. The threshold may be stored in the attachment alert policy 224, for example. An example of the data structure of the attachment alert policy 224 is illustrated in FIG. 11.

As exemplified in FIG. 11, the attachment alert policy 224 may include at least one of a threshold of the screen occupation ratio, a threshold of an attachment operation time duration, and the like. These thresholds maybe supplied or set in advance as policies. The attachment operation time duration represents one example of a selection operation time duration. The threshold of an attachment operation time duration will be described later. As described later, the attachment alert policy 224 may include other determination conditions.

For example, the determination unit 223 may select a threshold to be compared with the operation information, from multiple candidate thresholds stored in the attachment alert policy 224. As one example, the threshold of the screen occupation ratio may be set for each screen resolution in accordance with the resolution of the monitor, and the determination unit 223 may obtain a threshold, corresponding to the resolution of the monitor.

In the meantime, the number of icons 20a that can be displayed in the available display area 203 or 204 is relatively small for a lower resolution, and is increased with an increase in the resolution. Even in a higher resolution, a chance of selecting a wrong file is increased when there are a lot of icons 20a. For this reason, the threshold of the screen occupation ratio may be reduced with an increase in the resolution.

Note that the determination unit 223 may calculate thresholds other than the threshold of the screen occupation ratio. Other thresholds will be described later in a description of an example of operations set forth below.

The determination unit 223 compares the operation information with the threshold obtained as described above, to determine whether or not the operation information (e.g., the occupation ratio) exceeds the threshold. When the operation information exceeds the threshold, the determination unit 223 may instruct the attachment alert unit 225 to display a confirmation alert. Otherwise, when the operation information is equal to or less than the threshold, the determination unit 223 may not instruct a display of the confirmation alert.

Next, an example of operations of the determination unit 223 will be described with reference to several scenarios. Note that in the following descriptions, the available display area 203 or 204 in which attachment file selection operation are made, may be referred to as the “operation focus area”. A folder that is displayed in the available display area 204 and in which selection operations are made, may be referred to as the “operation focus folder”.

(1-3-1) Example of Operations When Operation Focus Area is Desktop

When the operation focus area is the desktop 201, in other words, when an attachment file is selected from multiple selection candidate files on the desktop 201, the determination unit 223 may execute processing as follows.

For example, the determination unit 223 may obtain the resolution of the monitor from the system information DB 232, and may calculate the occupation ratio of the multiple icons 20a on the screen based on the screen size of the desktop 201 and the view format of the icons 20a. The determination unit 223 may then obtain a threshold from the attachment alert policy 224, and may determine that a confirmation alert is to be issued when the icons 20a occupy a certain area exceeding a certain ratio (e.g., 70%) in the available display area 203.

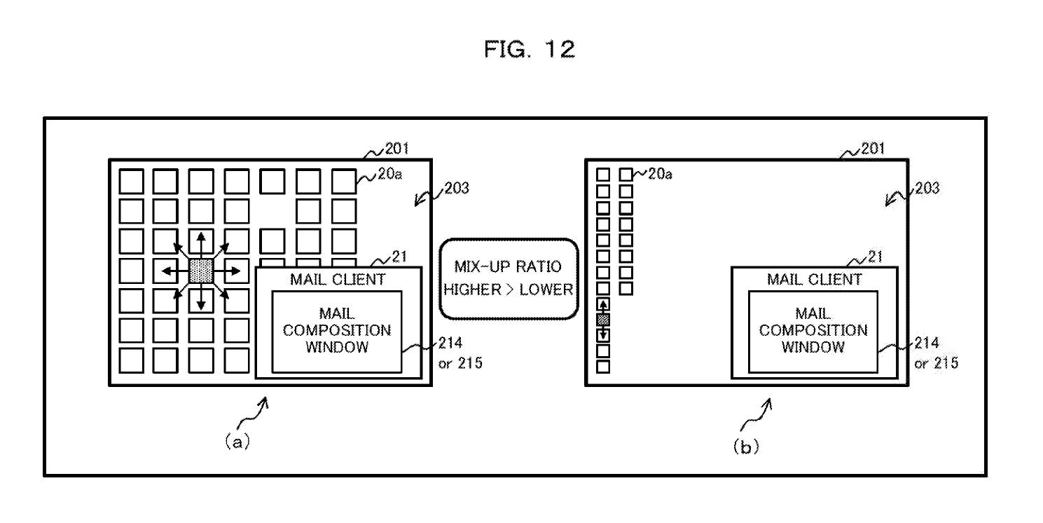

In the meantime, as exemplified in a reference sign (a) in FIG. 12, when the screen occupation ratio of the icons 20a exceeds the threshold, a selection-target icon 20a may possibly be hidden behind another window (e.g., the window of the mail client 21) and thus a file mix-up may possibly occur. In contrast, as exemplified in a reference sign (b) in FIG. 12, in a list display in a higher resolution, the screen occupation ratio of the icons 20a is equal to or less than the threshold, and all of the icons 20a can be visible in the list. Hence, a selection-target icon 20a is possibly not hidden behind another window, and a file mix-up may not possibly occur.

For the above reason, when a selection-target icon 20a may be highly possibly hidden behind another window, the possibility of a file mix-up may be determined as high, taking that window into consideration. For example, when the number of windows that run simultaneously is equal to or greater than a threshold, the determination unit 223 may determine that a selection-target icon 20a may be highly possibly hidden behind another window, and may determine that a confirmation alert is to be issued.

The number of windows that run simultaneously may be obtained by determining the number of applications that are currently being executed, based on the process information or the application information stored in the system information DB 232, for example. At this time, the sizes of the windows that run simultaneously may be taken into consideration. Alternatively, a detection as to whether or not icons 20a are hidden behind another window may be made with other techniques.

In another scenario, as depicted in the reference sign (a) in FIG. 12, when the shaded icon 20a is selected as an attachment file, for example, eight icons 20a are present adjacent to the attachment file in the eight directions around it and thus the possibility of a file mix-up is high. In contrast, in the example of the reference sign (b) in FIG. 12, since only two icons 20a are present adjacent to the attachment file in the two directions, the possibility of a file mix-up is lower than that in Case (a) in FIG. 12.

Hence, the determination unit 223 may determine that the possibility of a file mix-up is high when the number of files adjacent to the selected file is equal to or greater than a threshold, and may determine that a confirmation alert is to be issued.

In a further scenario, the icon 20a of files are irregularly placed on the desktop 201, a selection-target file may possibly be located in an area that is not expectable by a user. Situations where the icons 20a are irregularly placed involve the situation where the option for aligning the icons 20a is not activated or the option for placing the icons 20a in regular intervals is not activated in the system settings, for example.

Hence, the determination unit 223 may determine whether or not the icons 20a are regularly arranged on the desktop 201, for example. The determination unit 223 may determine that the possibility of a file mix-up is high when the icons 20a are irregularly placed, and may determine that a confirmation alert is to be issued.

In the meantime, icons 20a generally contain filenames. Since filenames are given to files by appending revision numbers of the files to the last parts (e.g., the ends) of the master file names, similar file names are provided in some cases. In other cases, long file names are highly probably omitted or hidden in their icons 20a.

For this reason, the determination unit 223 may determine whether or not files have similar file names or check the lengths of the file names, to determine whether or not there are any files having file names similar to that of the selected file, and/or to determine whether or not the entire file name is displayed. When there are any files having file names similar to that of the selected file or when the entire file name is not displayed, the determination unit 223 may determine that the possibility of a file mix-up is high and decide that a confirmation alert is to be issued.

In other words, when a file is selected, the determination unit 223 may obtain information on the length of the file name from the system information DB 232. The determination unit 223 may then calculate that the entire file name is displayed in a display of the icon 20a or the like, compare the calculation result with a threshold of determining wrong file attachment, and determine whether to issue a confirmation alert.

When detecting files having file names similar to that of the selected file, the determination unit 223 may take at least one of the following Conditions (i) to (iv) into consideration, for example:

(i) whether or not the number of selection candidate files having the same extension to that of the selected file is equal to or greater than a threshold;

(ii) whether or not there are any files having file names, the first x letters (x is an integer, for example “5”) of which match the first x letters of the filename of the selected file, in the operation focus folder;

(iii) whether or not there are any files which were accessed during a certain time period (e.g., recently) in the operation focus folder, beside the selected file, and

(iv) whether or not there are any files with icons 20a that have similar colors to the color of the icon 20a of selected file, in the operation focus folder.

For example, when one of Conditions (i) to (iv) is affirmative (e.g., when the number is equal to or greater than the threshold or when there are any files), the determination unit 223 may select files satisfying any of Conditions (i) to (iv), as “similar file” candidates.

For example, after a startup of the computer 2 or the mail client 21 or during a composition of a mail, the determination unit 223 may identify and classify folders that can be selection operation candidates in the computer 2, for category of Conditions (i) to (iv). For example, each folder maybe classified in advance, for each extension for Condition (i), for the first x letters of file names for Condition (ii), in the order of the access time (e.g., latest operation) for Condition (iii), or for each color for Condition (iv). Examples of folders that can be selection operation candidates include the desktop 201, or folders that can gain an operation focus folder, such as a download folder, and a document folder, for example.

The above-described thresholds, determination condition, and the like may be set in advance in the attachment alert policy 224. Examples of the thresholds include thresholds of the number of windows or the window size, and threshold of the number of files adjacent to the selected file, for example. Examples of the determination conditions include a condition to determine whether or not icons 20a are regularly arranged, a condition to determine whether or not there are similar files, and a condition to determine whether or not parts of file names are hidden.

In this manner, the determination unit 223 may obtain the sizes of icons 20a and the resolution of the screen when a file is selected on the desktop 201. The determination unit 223 may then calculate the occupation ratio of all of the multiple icons 20a, to the available display area 203 of the desktop 201 (e.g., the entire screen of the display), compare the occupation ratio with a threshold of an attachment of a wrong file, and determine whether to issue a confirmation alert.

(1-3-2) Example of Operations When Operation Focus Area is Window

When the operation focus area is the window 205, in other words, when an attachment file is selected from multiple selection candidate files displayed in the window 205, the determination unit 223 may execute processing as follows.

As set forth above, the window 205 may be a folder window used in the drug method, or the file selection window 216 or 217 used in the selection operation method. Further, in the following descriptions, icons 20a may be displayed in any view format: the icon view format, the list view format, or the detailed view format.

For example, when a file is selected in a certain folder, the determination unit 223 may obtain display status-related information, such as the display layout, the size of the window 205, and the sizes of icons 20a. The determination unit 223 may then calculate the occupation ratio of all of the multiple icons 20a, to the available display area 204 of folders, compare the occupation ratio with a threshold of an attachment of a wrong file, and determine whether to issue a confirmation alert.

In the manner similar to cases where an operation focus area is the desktop 201, the determination unit 223 may also determine whether to display a confirmation alert, based on other determination conditions. For example, the determination unit 223 may determine at least one of the following: whether or not icons 20a are hidden behind another window, the number of files adjacent to the selected file, whether or not there are any similar files, and whether or not a part of the name of the selected file is hidden.

The determination unit 223 may execute the following processing, depending on whether or not all of the icons 20a are displayed within the available display area 204.

(1-3-2-1) All Icons Are Displayed Within Available Display Area

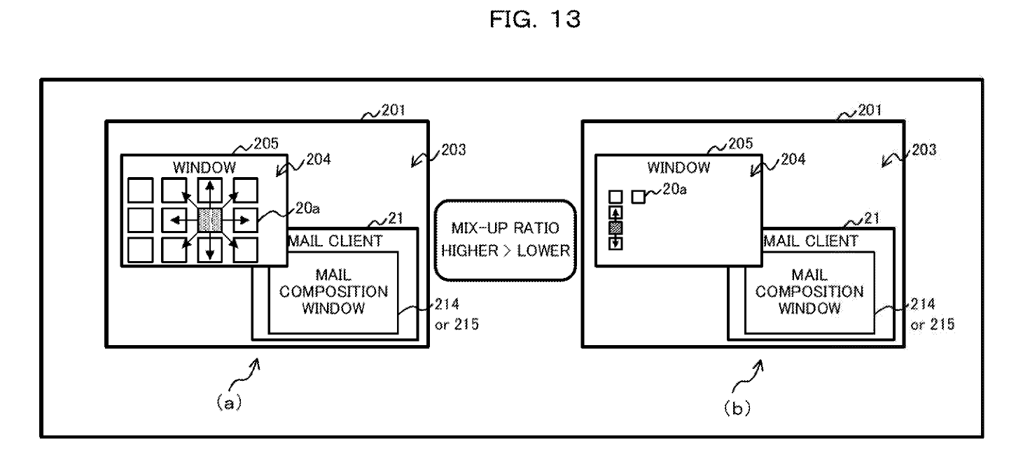

As exemplified in FIG. 13, when all of the icons 20a are displayed within the available display area 204, the icons 20a are displayed in the manner similar to the example in FIG. 12, except that the icons 20a of selection candidates are present in the available display area 204 within the window 205.

Therefore, when an operation focus area is the window 205 and all of the icons 20a are displayed within the available display area 204, the determination unit 223 may execute processing similar to that in the case where an operation focus area is the desktop 201 (refer to FIG. 12). In this case, the determination unit 223 may determine the screen occupation ratio based on the display size, e.g., the resolution, of the available display area 204, in place of the screen resolution of the desktop 201.

(1-3-2-2) When Some of Icons Are Not Displayed in Available Display Area

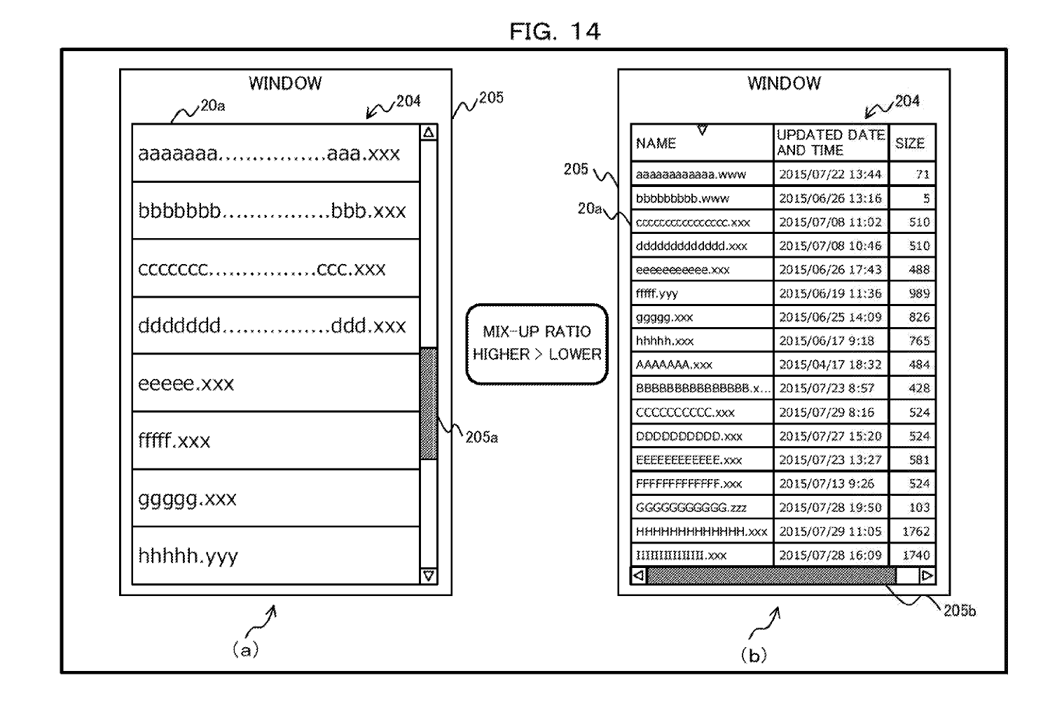

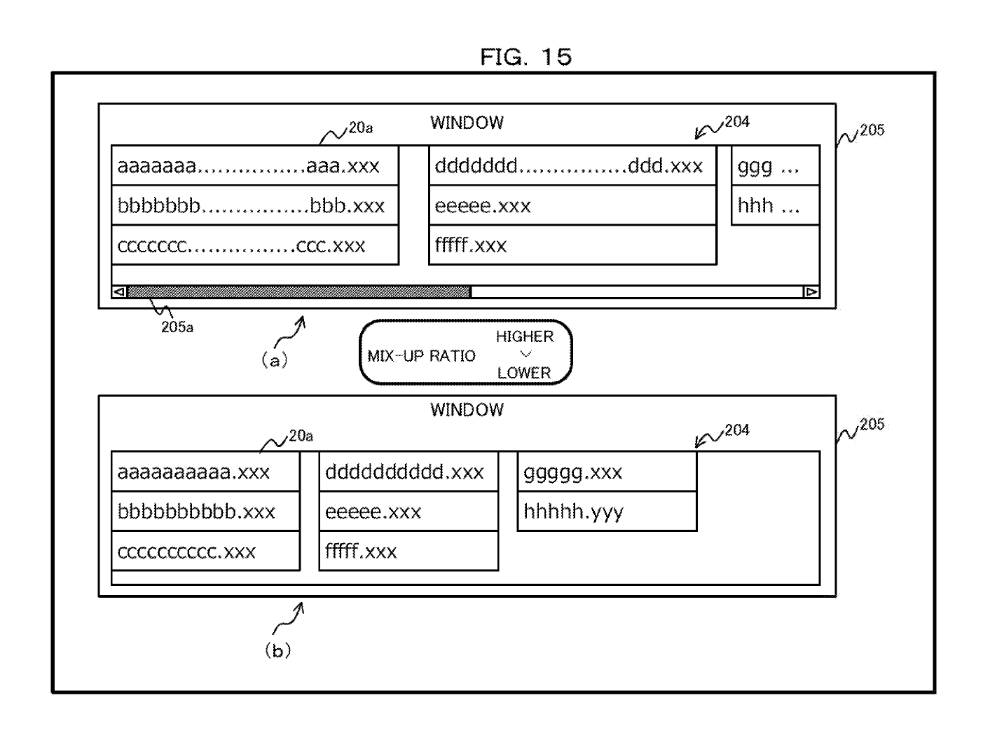

When at least one of multiple icons 20a is not displayed within the available display area 204, as exemplified in a reference sign (a) in FIG. 14 and a reference sign (a) in FIG. 15, the available display area 204 maybe scrolled for checking selection of a file.

When the available display area 204 is scrollable, for one or more of icons 20a of files, at least some of those icons 20a are not displayed in the available display area 204.

For example, in the reference sign (a) in FIG. 14, which indicates that a vertical scroll operation is made for checking selection, since a vertical scroll can be made, additional icons 20a of files may be present above the icon 20a of “aaaaaaa...aaa.xxx” and/or below the icon 20a of “hhhhh.yyy”. For example, in the reference sign (a) in FIG. 15, which indicates that a horizontal scroll operation is made for checking selection, since a horizontal scroll can be made, parts of the file names of the icons 20a of “ggg...” and “hhh...” are not displayed and additional icons 20a of files may be present in the right of the icons 20a of “ggg...” and “hhh...”.

Accordingly, when the window is scrollable in the direction where the icons 20a are aligned, the possibility of a file mix-up is higher than the cases in a reference sign (b) in FIG. 14 or a reference sign (b) in FIG. 15 where the window is not scrollable in that direction. Note that the reference sign (b) in FIG. 14 and the reference sing (b) in FIG. 15 indicate that no vertical/horizontal scroll operation is required and items are viewed in list, respectively.

Accordingly, when an attachment file is selected within the window 205, the determination unit 223 may check the size of the window 205 being displayed and the view format of icons 20a, determine how the icons 20a are being displayed on the screen of the available display area 204. The determination unit 223 then may determine whether or not a scroll operation is to be made for checking files or all selection candidate files are being displayed in the available display area 204 in a list, based on the number of selection candidate files being displayed in the available display area 204.

When the window is scrollable and one or more of selection candidate files are not displayed in the available display area 204, the determination unit 223 may determine that the possibility of a file mix-up is high and determine that a confirmation alert is to be issued.

Note that whether a scroll operation is to be made may be determined by a presence or absence of a scroll bar 205a, for example. Alternatively, the above-described determination maybe made based on thresholds, such as a threshold of the scroll amount, a ratio of icons 20a displayed in the available display area 204 to icons 20a that are not displayed (e.g., a ratio of the number or the display area).

As set forth above, the determination unit 223 may check the display status of a folder as to whether a scroll operation is to be made for checking selection of a file, compare the status with a condition for determining that a wrong file is attached, and determine whether to issue a confirmation alert.

In reference sign (b) in FIG. 14, a horizontal scroll bar 205b is present in the detailed view format. In other words, window is scrollable in the direction vertical to the direction where the icons 20a are aligned. In this case, however, all file names are displayed in the available display area 204, the possibility of a file mix-up can be regarded as low. Therefore, in the example of reference sign (b) in FIG. 14, the determination unit 223 may determine not to issue a confirmation alert.

(1-3-3) Determination Processing in Accordance With Attachment Operation Time Durations

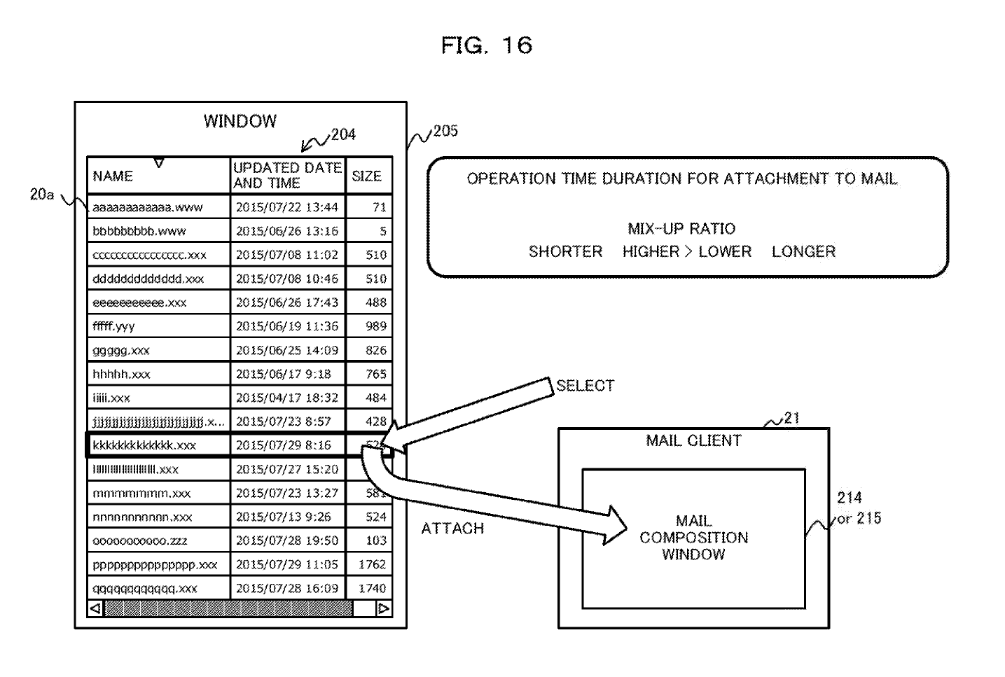

As exemplified in FIG. 16, the file mix-up ratio may be varied over an attachment operation time duration for an operation to attach a file to a mail.

The attachment operation time duration is a time duration from when a file is selected until when the file is attached in the mail composition window 214 or 215, for example. As one example, in the drug method, the attachment operation time duration may be a time duration from when a selection and drug of a file is initiated until when the file is dropped into the mail composition window 214 or 215.

For example, a shorter attachment operation time duration may possibly indicate that a user made a file attachment operation hastily, in other words, the user probably did not pay an attention sufficient to check the file name and the like, meaning a higher possibility of a file mix-up. In contrast, a longer attachment operation time duration enables the user to check the file name while drugging it, and the mix-up ratio may be low.

Accordingly, when the time duration from when a file is selected until when the file is attached to a mail is shorter than a threshold, the determination unit 223 may determine that a confirmation is not sufficient and thus the possibility of an attachment of a wrong file is high and may determine that a confirmation alert is to be issued. In this case, the determination unit 223 may obtain times when the attachment operation was initiated and completed, from the file operation log 222, calculate the attachment operation time duration, and compare the calculated attachment operation time duration with a threshold set in the attachment alert policy 224, for example.

Note that the threshold of an attachment operation time duration may be a time duration (e.g., two seconds) that is sufficiently long to check the file name while the file is being dragged. Alternatively, the threshold of an attachment operation time duration may be varied in accordance with the processing performance, the screen resolution, and the like, of the computer 2. For example, when the processing performance and the screen resolution are low, it may be difficult to check the file name while the file is being dragged. For this reason, the determination unit 223 may set a higher threshold of an attachment operation time duration, as the processing performance, the screen resolution, and the like are reduced.

The attachment operation time duration may also be defined as follows. For example, when a copy-and-paste is used in the drug method, the attachment operation time duration may be a time duration from when a file is selected and copied until when the file is pasted in the mail composition window 214 or 215.

Alternatively, in the selection operation method, the attachment operation time duration may be a time duration from when a file is selected (e.g., activated) until when a button to confirm an attachment (e.g., refer to the OK button 216a in FIG. 5) is depressed.

While FIG. 16 illustrates a case where an operation focus area is the window 205, the determination unit 223 may also execute processing when the operation focus area is the desktop 201.

As set forth above, the determination unit 223 may determine whether to issue a confirmation alert, taking a mix-up of files on the desktop 201 or in the window 205, a mix-up of files caused by a scroll operation, a mix-up of files caused by the moving speed, and the like, into consideration.

In this configuration, since whether to display a confirmation alert is determined flexibly from the statuses of the locations where files are saved, and the status of an operation, in response to an attachment of a file to a mail, the risk of a file mix-up can be reduced.

In other words, the determination unit 223 represents one example of a detecting unit that detects the size of the available display area 203 or 204 for displaying respective selection areas associated with multiple selection candidate files that are selectable as an operation-target file, and the total display size of the selection areas for the selection candidate files displayed on the available display area 203 or 204.

(1-4) Description of Attachment Alert Unit

Next, an example of operations of the attachment alert unit 225 will be described. The attachment alert unit 225 may display a confirmation alert that prompts a user to check an attachment file, when the determination unit 223 determines to display a confirmation alert for the attachment file. Note that a processing to display a confirmation alert for an attachment file by the attachment alert unit 225 maybe embodied as an extension of a confirmation alert for an outgoing mail issued by the transmission alert unit 226 in response to a transmission of the mail.

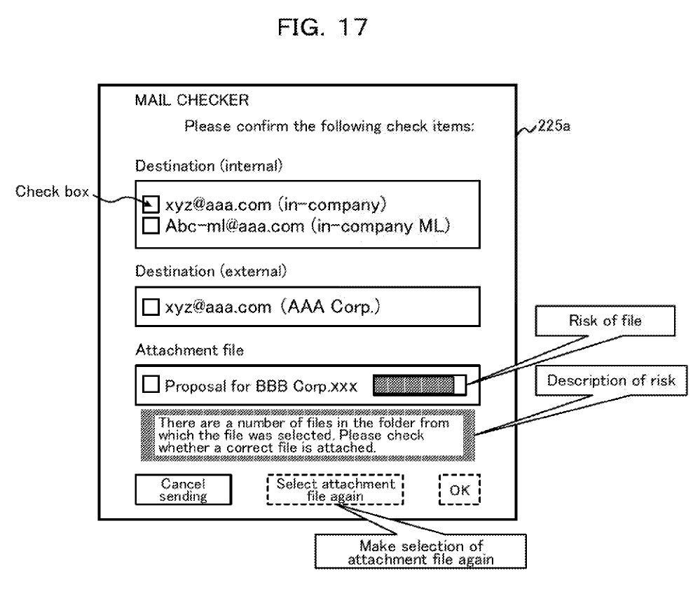

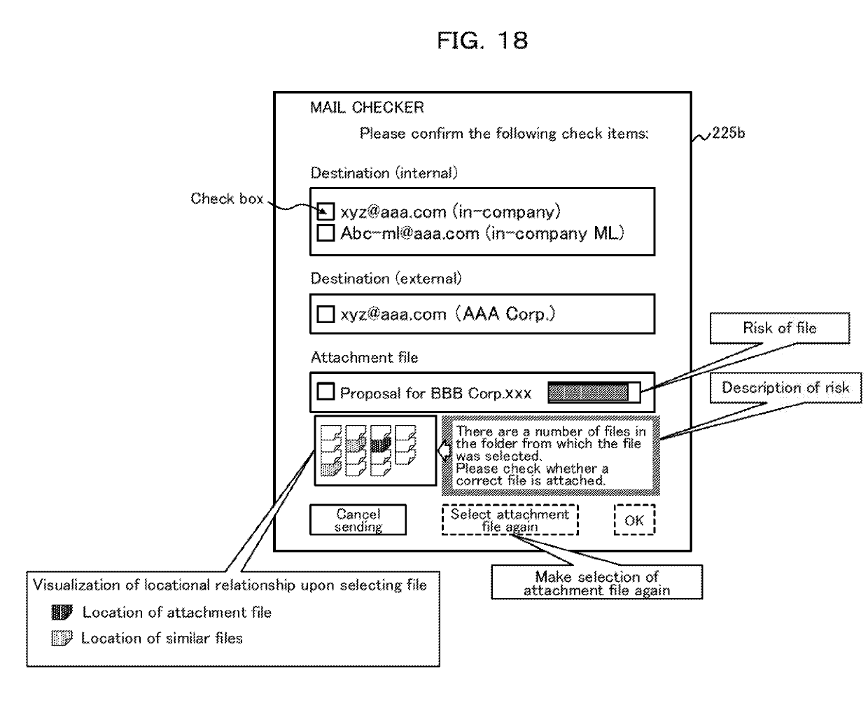

FIGS. 17 and 18 are diagrams illustrating an example of a display of check alert screens 225a and 225b for attachment files. As depicted in FIGS. 17 and 18, the windows of the check alert screens 225a and 225b may include information of destinations of a mail (e.g., internal and external destinations), and information of an attachment file name, the risk of the attachment file, and the description of the risk, as an example. As depicted in FIG. 18, the check alert screen 225b may also include a graphical representation of the locational relationship upon a file selection. Note that the locational relationship upon a file selection may indicate the location of the attachment file and the locations of the similar files such that they are distinguishable.

The “Cancel sending”, “Select attachment file again”, and “OK” buttons may be displayed on the check alert screens 225a and 225b. The “Cancel sending” button is a button for stopping sending a mail when the user notices that a wrong file was possibly selected as an attachment, for example. The “Select attachment file again” button is a button for selecting a correct attachment file, for example. The “OK” button is a button for continue to edit the mail without making a reselection.

In the examples of FIGS. 17 and 18, a check box may be provided for each item to be checked in the check alert screens 225a and 225b, and the user may check these items and click the check boxes after confirming that they are correct. Note that the “OK” button or other items in the check alert screens 225a and 225b may be configured such that they can be selected only after all of the check boxes are checked (all of the items are confirmed).

In this manner, the user may be prompted to check the “Proposal for BBB Corp.xxx” attachment file, for example. The risk of a file and the description of the risk provide the user with the possibility that a wrong file has been selected as an attachment, and the reason for a wrong selection, in a detailed manner. Further, in the example in FIG. 18, the locational relationship upon a file selection is graphically represented in the check alert screen 225b, to indicate similar files of the attachment file and the like to the user in a detailed manner.

Accordingly, since it is possible to make a user thoroughly consider the possibility that a wrong file has been selected as an attachment, in addition to simply making a user confirm an attachment file as a correct one, the risk of a file mix-up can be reduced.

Here, the risk of the attachment file maybe calculated by the attachment alert unit 225, based on the result of the determination made by the determination unit 223, for example. As one example, the risk of the attachment file may be obtained by calculating the ratio of the number of types of determinations as a wrong selection by the determination unit 223, to the number of determination types made by the determination unit 223. Note that “the determination types” refer to types of determinations, including a determination of the screen occupation ratio, determination of scrollable or not, a determination of attachment operation time durations, and the like.

Furthermore, respective descriptions of the risks may be displayed corresponding to determination types with which the determination unit 223 has made a determination as a wrong selection, and descriptions of high-priority determination types may be selectively displayed, based on priorities predetermined for each determination type. Alternatively, descriptions may be displayed for a determination type which has a large discrepancy with the determination conditions, e.g., thresholds.

Further, the locational relationship upon a file selection may be generated by the attachment alert unit 225 in a diagram or table indicating the locational relationship of the attachment file and similar files, or may be generated based on thumbnails or reduced images of the available display area 203 or 204, for example.

As set forth above, displays of the risk of an attachment file, the description of the risk, the locational relationship upon a file selection, and the like enable effective utilization of determination results by the determination unit 223, and also enable provisions of useful information to users for making a reselection of an attachment file.

Note that the display of a confirmation alert by the attachment alert unit 225 maybe issued in response to a selection operation or an attachment operation of a file, and may also be issued in response to a mail transmission operation.

The confirmation alerts are not limited to the window displays, such as the check alert screen 225a or 225b described above, and may be displayed as pop-ups or menus, for example.

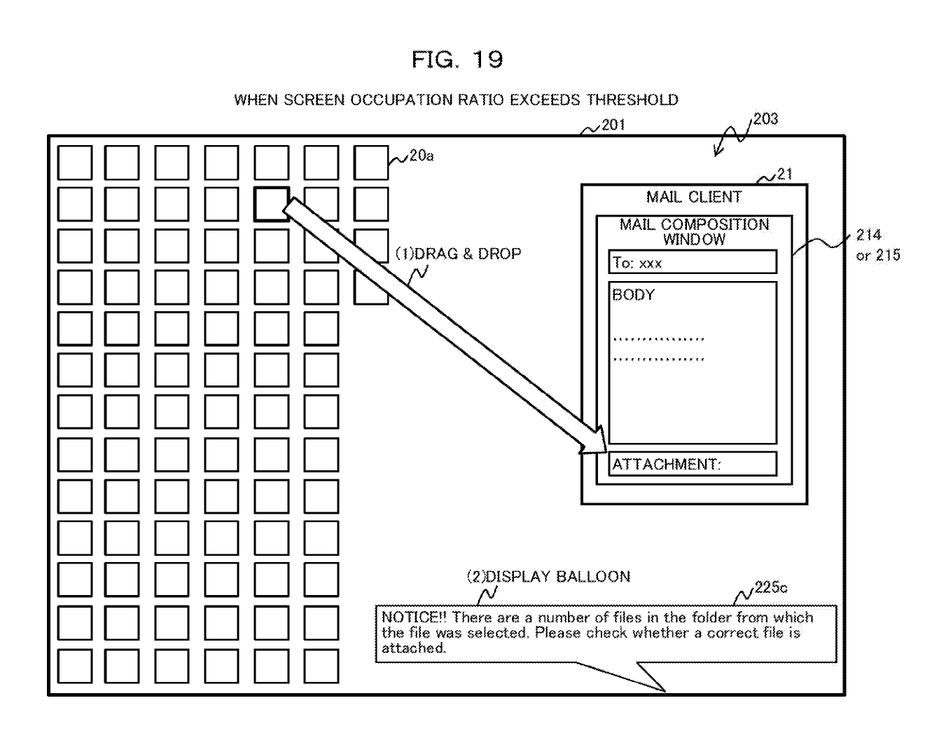

As one example, as depicted in FIG. 19, when a file is drugged and dropped into the mail composition window 214 or 215 (refer to (1) in FIG. 19), the attachment alert unit 225 may display as pop up a balloon containing the description of the risk (refer to (2) in FIG. 19). Note that the balloon is one example of the attachment alert screen 225c.

In other words, the attachment alert unit 225 represents one example of an alert unit that outputs an alert prompting a confirmation of the selected file as an operation-target file when the ratio of the total display size of the multiple icons 20a to the size of the available display area 203 or 204 exceeds a threshold.

As exemplified in FIG. 19, a display of the balloon 225c may also be used when a file is saved from the mail client 21 or a browser, or when a file operation is made, such as copy or backup processing of a file.

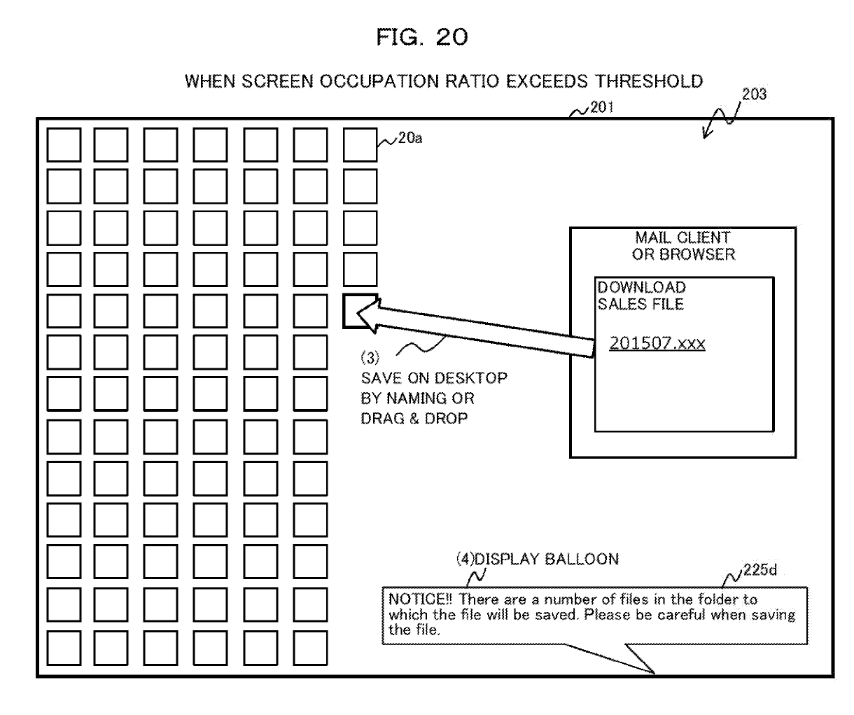

As one example, as depicted in FIG. 20, when a file is saved to the desktop 201 from the mail client 21 or a browser or the like (refer to (3) in FIG. 20), a balloon containing the description of the risk may be popped up (refer to (4) in FIG. 20). Note that the balloon represents one example of a save alert screen 225d.

(1-5) Example of Operations

Next, an example of operations of the system 1 configured as described above will be described.

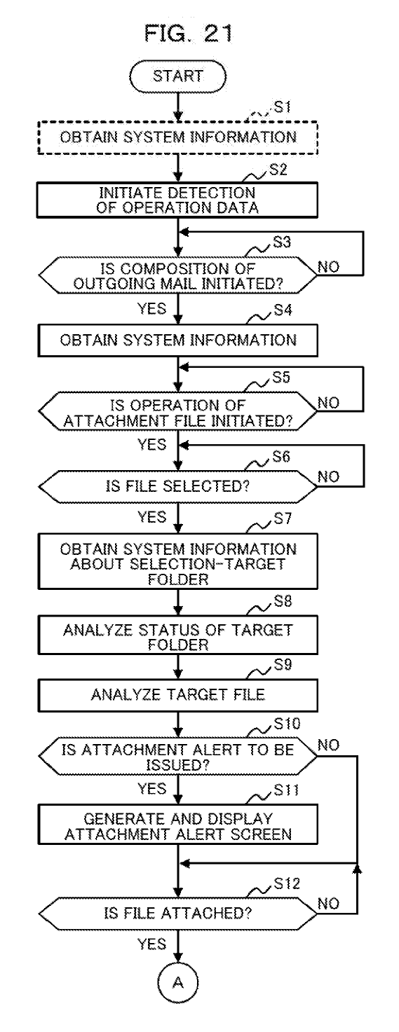

As depicted in FIG. 21, after a startup of the computer 2 or a startup of the mail client 21, for example, the obtainment unit 231 in the system information obtainment tool 23 may obtain the system information (Step S1).

The operation detecting unit 221 in the mail checker 22 may initiate to detect an operation log (may also be referred to as “operation data” hereinafter) (Step S2), once the mail client 21 is started, for example. The detection of the operation data may involve processing to store the detected operation data to the file operation log 222. Note that the operation data may include date and time when outgoing mails were composed, date and time of file selection operations, and records of operations by users of the input device 24 (e.g., a mouse or a keyboard), such as mouse and keyboard operations and entered contents, for example.

Next, the operation detecting unit 221 waits until an outgoing mail is composed (No from Step S3). Once an outgoing mail composition is initiated (Yes from Step S3), the obtainment unit 231 may obtain the system information (Step S4).

The system information obtained in Step S1 or S4 may be information on the desktop 201 and the window 205 used for an analysis of an attachment file (may also be referred to as “file-related data” hereinafter). As one example, the file-related data may include information, such as the display size or the resolution, the view format, the colors of the desktop 201. Note that the processing in Step S1 may be omitted when the processing in Step S4 is executed.

Note that in Step S4, the determination unit 223 may identify and classify files in the operation focus folder for each category. Examples of the categories include the information on Conditions (i) to (iv) used for detecting similar files (e.g., extensions, the first x letters of file names, the time order, colors, and the like).

Next, the operation detecting unit 221 waits until an operation of an attachment file is initiated (No from Step S5). Once the operation of the attachment file is initiated (Yes from Step S5), the operation detecting unit 221 waits until a file is selected (No from Step S6). When a file is selected, e.g., drugged, copied, or activated (Yes from Step S6), the obtainment unit 231 may obtain the system information on the selection-target folder (Step S7).

The system information obtained in Step S7 may include the view format of an operation focus folder, e.g., the folder displayed in the available display area 204, the size of icons 20a, and the like. Note that the system information on the desktop 201, and system information on folders other than the operation focus folder may not be obtained, e.g., system information on folders one-level higher in the hierarchy, for example.

Next, the determination unit 223 may analyze the status of the target folder based on the system information DB 232 (Step S8). The analysis in Step S8 may involve obtaining the screen occupation ratio, the sizes and colors of icons 20a, and the like, and making a determination by comparing the obtained information with a threshold set in the attachment alert policy 224.

The determination unit 223 may also analyze the target file, based on the system information DB 232 and the file operation log 222 (Step S9). The analysis in Step S9 may involve identifying similar files of the selected file, and making a determination by comparing with the threshold.

The determination unit 223 determines whether to issue an attachment alert, based on the result of the determination (Step S10). This determination may also include determining whether to display an attachment alert depending on the result of the determination, and determining whether to display an attachment alert in response to a selection of a file.

When an attachment alert is to be issued (Yes from Step S10), the determination unit 223 outputs the result of the determination to the attachment alert unit 225. The attachment alert unit 225 generates an attachment alert window (e.g., one of the attachment alert screens 225a-225c), based on the result of the determination from the determination unit 223, and displays it on the desktop 201 and the like, as a window view, a pop-up view, a menu view, or the like (Step S11). Otherwise, when an attachment alert is not to be issued (No from Step S10), the flow transitions to Step S12.

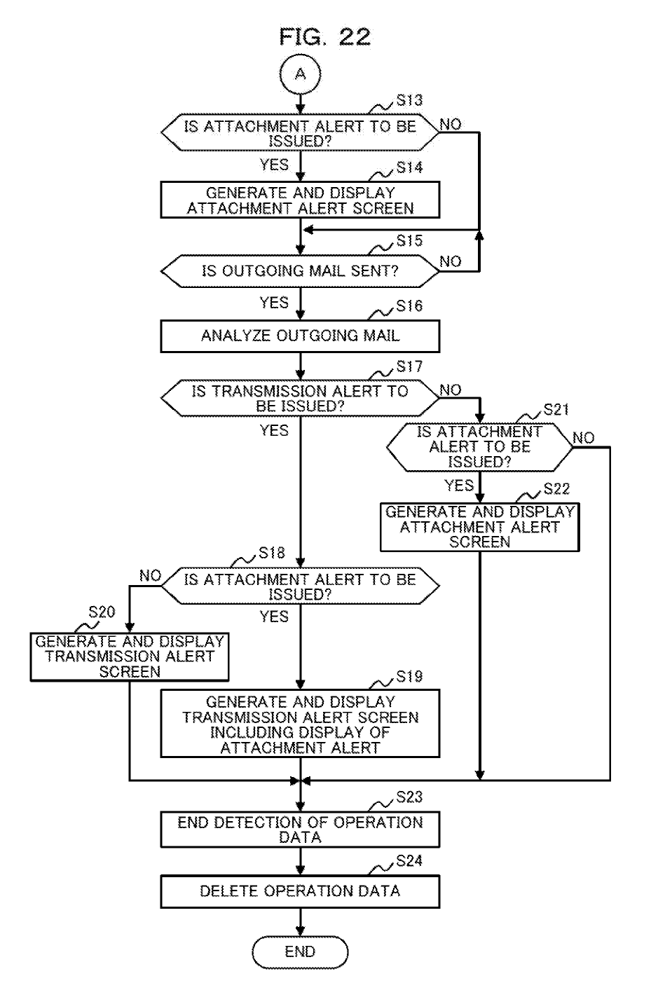

In Step S12, the operation detecting unit 221 waits until a file is attached to a mail (No from Step S12). When a file is attached, e.g., dropped or pasted (Yes from Step S12), as exemplified in FIG. 22, the determination unit 223 determines whether to issue an attachment alert, based on the result of the determination (Step S13). This determination may also include determining whether to display an attachment alert depending on the result of the determination, and determining whether to display an attachment alert in response to an attachment of a file.

When an attachment alert is to be issued (Yes from Step S13), the determination unit 223 outputs the result of the determination to the attachment alert unit 225. The attachment alert unit 225 generates an attachment alert window, based on the result of the determination from the determination unit 223, and displays it on the desktop 201 and the like, as a window view, a pop-up view, a menu view, or the like (Step S14). Otherwise, when an attachment alert is not to be issued (No from Step S13), the flow transitions to Step S15.

In Step S15, the operation detecting unit 221 waits until an outgoing mail is sent (No from Step S15). When an outgoing mail is sent (Yes from Step S15), the transmission alert unit 226 analyzes the outgoing mail (Step S16), and determines whether to issue a transmission alert based on the result of the determination (Step S17). This determination may also include determining whether to display a transmission alert depending on the result of the determination.

When a transmission alert is to be issued (Yes from Step S17), the attachment alert unit 225 determines whether to issue an attachment alert (Step S18). When an attachment alert is to be issued (Yes from Step S18), the attachment alert unit 225 generates and displays a transmission alert screen including a display of an attachment alert, in cooperation with the transmission alert unit 226 (Step S19) and the flow transitions to Step S23.

When an attachment alert is not to be issued in Step S18 (No from Step S18), the transmission alert unit 226 generates and displays a transmission alert screen (Step S20) and the flow transitions to Step S23.

When a transmission alert is not to be issued in Step S17 (No from Step S17), the attachment alert unit 225 determines whether to issue an attachment alert (Step S21). When an attachment alert is to be issued (Yes from Step S21), the attachment alert unit 225 generates and displays an attachment alert screen (Step S22), the flow transitions to Step S23.

In the meantime, when an attachment alert is not to be issued in Step S21 (No from Step S21), neither transmission alert screen nor attachment alert screen is generated and the flow transitions to Step S23.

In Step S23, the operation detecting unit 221 may terminate to detect the operation data. Note that the operation detecting unit 221 may continue to detect the operation data until the mail client 21 is terminated, for example.

Next, the operation detecting unit 221 deletes a series of operation data (Step S24), and the flow terminates. The series of operation data may be operation data related to the outgoing mail. Note that the deletion is made after the outgoing mail is sent, or operation data related to the previous outgoing mail maybe deleted when a new outgoing mail is composed. Alternatively, the operation data in the file operation log 222 may be deleted when the mail client 21 is terminated or started.

As set forth above, in the system 1 according to one embodiment, the computer 2 may obtain system information, and compare the status of a file attachment and the applied policy and make a determination, as a security countermeasure related to a prevention of attachments of wrong files to outgoing mails. The computer 2 may also calculate the occupation ratio of all of the multiple icons 20a to the available display area 203 or 204 based on the display size of a single icon 20a, determine the risk of the attachment file, and may issue a confirmation alert for the attachment file. This can prevent information leakage caused by selections of wrong files as attachments to outgoing mails.

Furthermore, the determination as to whether to display a confirmation alert may be made by determining the usage statuses, e.g., the size of the available display area 203 or 204 and the display size of icons 20a, and quantifying the possibility of selecting a wrong icon 20a based on the applicable policy. This can reduce annoying notifications or confirmations to or by users, such as displaying alerts, prompting users to make confirmations, and automatically suspending outgoing mails, every time an attachment file is operated or a mail is sent.

Among information leakage incidents, security incidents caused by erroneous mail transmissions and information leakage due to erroneous mail transmissions through “careless mistakes” are inevitable. The “Report on Surveys on Information Security Incidents in 2013-Private Information Leakage-” issued by Japan Network Security Association (JNSA) on Dec. 25, 2014, has reported that Information leakage caused by erroneous operations topped in the ranking of “percentages of causes of leakage (number of incidents)”.

In accordance with this disclosure, the transmission alert unit 226 and the transmission alert policy 227 as one example of an outgoing mail checker may check possible erroneous mail transmissions in response to transmissions of mails, and prompt a user to confirm a transmission risk, such as a possibility of a wrong destination address or an attachment of a wrong file. This can prevent erroneous mail transmissions, and prevent information leakage due to “careless mistakes”.

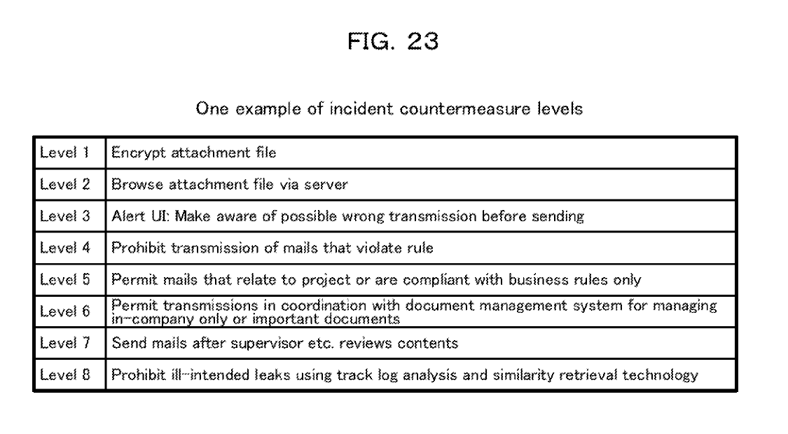

In the case of an outgoing mail checker, countermeasures can be taken against incidents in Levels 3 and 4 of, as depicted in FIG. 23, for example. Note that countermeasures becomes more difficult as the level is higher, in the example in FIG. 23.

In contrast, the operation detecting unit 221, the file operation log 222, the determination unit 223, the attachment alert policy 224, and the attachment alert unit 225, as one example of an attachment file checker, can provide countermeasures in Levels 5 and 6, for example.

For example, with the attachment file checker, the following file selection error cases where a wrong file is attached to a mail, can be addressed:

(a) A proposal file for A Corporation is erroneously attached to a mail addressed to B Corporation, followed by a transmission of the mail.

(b) An obsolete proposal file including internal-only information is erroneously attached to a mail addressed to C Corporation, followed by a transmission of the mail.

(c) Under the rule, different folders must be created for different customers. Files for different customers, however, are saved on the desktop. A file for E Corporation is erroneously attached to a mail addressed to D Corporation, followed by a transmission of the mail.

The computer 2 according to one embodiment can prevent Cases (a) to (c) described above.

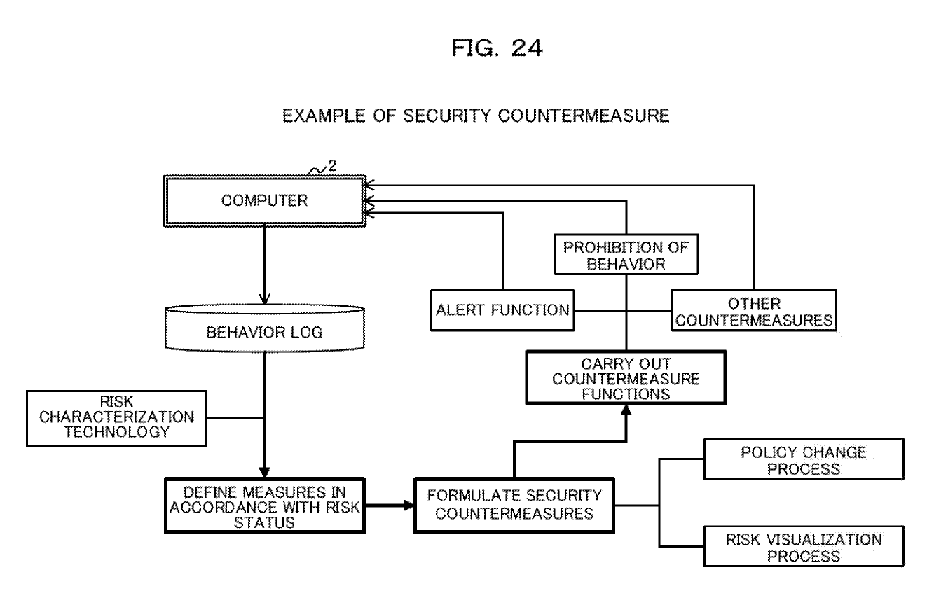

Note that the example of operations of one embodiment can be applied to examples of security countermeasure, such as that depicted in FIG. 24.

In the example of a security countermeasure illustrated in FIG. 24, a behavior log in the computer 2 is accumulated in the file operation log 222, for example, and countermeasure rules for the risk status may be defined based on the behavior log, by the risk characterization technology, e.g., the determination processing by the determination unit 223. A mechanism for detecting possible excessive countermeasures by the determination unit 223 and the attachment alert unit 225 may be incorporated in the countermeasure rules for the risk status.

Furthermore, security countermeasures may be defined based on the countermeasure rules for the risk status. The security countermeasure may include a policy change process and a risk visualization process. The policy change process may involve analyzing a determination result by the determination unit 223 and changing the attachment alert policy 224 based on the result of the analysis, for example. The risk visualization process may involve processing of visualizing risks that become apparent through the definition of the security countermeasures.

Then, the countermeasure functions may be carried out based on the defined security countermeasure. The countermeasure functions may include an alert function, a prohibition of behavior, and other countermeasures. An example of the alert function is issuing an attachment alert by the attachment alert unit 225, for example. The prohibition of behavior and other countermeasures may also be embodied by a wide variety of well-known techniques, based on security countermeasures and a determination result by the determination unit 223.

Note that results of countermeasure functions may be fed back to a user of the computer 2, thereby realizing continuous and effective security countermeasures.

### (2) Miscellaneous

The above-described technique according to one embodiment may be practiced in modifications and variations as follows:

For example, the function blocks of the computer 2 illustrated in FIG. 8 may be combined in any combinations or may be divided.

While a selection of a wrong file has been described in the context of attaching a file to an outgoing mail in one embodiment, this is not limiting and the disclosure may be applied to other file operations, such as save, copy, and backup processing of files.

With regard to saving files, the terms “operation focus area” and “file selected from operation focus area” in this description may be replaced with “save destination folder” and “file saved in the save folder”, respectively.

With regard to copy or backup of files (also simply referred to as “copy” hereinafter), the term “operation focus area” may be replaced with either or both of a “copy source display area” (e.g., a copy source folder) of a file, and a “copy destination display area” (e.g., a copy destination folder) of a file.

With regard to copy of a file, a copy or selection of a file from a “copy source display area” may correspond to a selection of a file from operation focus area in the technique according to one embodiment. Further, a paste of a file to a “copy destination display area” may correspond to saving a file to a “save destination folder”. Accordingly, when the term “operation focus area” is replaced with both of a “copy source display area” and a “copy destination display area” of a file, the attachment file checker may determine possibility of a wrong selection for both the “copy source display area” and the “copy destination display area”.

In one aspect, the risk of a file mix-up can be reduced.

All examples and conditional language recited provided herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A file operation check apparatus comprising:
a memory; and
a processor coupled to the memory, the processor configured to:
detect a size of a display area for displaying respective selection areas associated with a plurality of selection candidate files that are selectable as an operation-target file, and a total display size of the selection areas for the selection candidate files displayed on the display area; and
output an alert for prompting a confirmation of the file selected as the operation-target file, when a ratio of the total display size to the size of the display area exceeds a threshold.

2. The file operation check apparatus according to claim 1, wherein the processor is further configured to:
obtain display status-related information including a resolution of a monitor for displaying the display area, and a display size of the selection area per file; and
calculate the ratio, based on the obtained display status-related information.

3. The file operation check apparatus according to claim 1, wherein the processor is further configured to:
obtain display status-related information including a window size of the display area, information about an arrangement of the selection areas in the display area, and a display size of the selection area per file; and
calculate the ratio, based on the obtained display status-related information.

4. The file operation check apparatus according to claim 3, wherein the processor is further configured to:
output the alert, based on whether the display area is scrollable or not.

5. The file operation check apparatus according to claim 1, wherein the processor is further configured to:
output the alert, when a time duration from when the operation-target file is selected until when the operation-target file is operated, is shorter than a time threshold.

6. The file operation check apparatus according to claim 1, wherein the processor is further configured to:
determine whether to display a file name of the operation-target file on the display area, based on information about a length of the file name of the operation-target file; and
output the alert, based on the determination result.

7. The file operation check apparatus according to claim 6, wherein the processor is further configured to:
output the alert, based on whether there is any file having a file name similar to the file name of the operation-target file, among the plurality of selection candidate files displayed on the display area.

8. The file operation check apparatus according to claim 1, wherein the processor is further configured to:
output the alert, based on a probability that another display area hinders at least a part of area of the display area from being displayed on a monitor.

9. The file operation check apparatus according to claim 1, wherein the processor is further configured to:
output the alert, based on a count of the selection candidate files displayed adjacent to the operation-target file, in the display area.

10. The file operation check apparatus according to claim 1, wherein the processor is further configured to:
output the alert, based on whether or not the plurality of selection areas are arranged regularly in the display area.

11. The file operation check apparatus according to claim 1, wherein the alert output by the processor includes information indicative of a degree of a probability that a wrong file has been selected as the operation-target file.

12. The file operation check apparatus according to claim 1, wherein the processor is further configured to:
output the alert, in response to a selection of the operation-target file, or an operation on the operation-target file.

13. The file operation check apparatus according to claim 12, wherein
the operation on the operation-target file is an attachment to an outgoing mail, and
the processor is further configured to:
output the alert, in response to a transmission of the mail to which the operation-target file is attached.

14. A non-transitory computer-readable storage medium having a file operation check program stored therein, the file operation check program causing a computer to execute a process comprising:
detecting a size of a display area for displaying respective selection areas associated with a plurality of selection candidate files that are selectable as an operation-target file, and a total display size of the selection areas for the selection candidate files displayed on the display area; and
outputting an alert for prompting a confirmation of the file selected as the operation-target file, when a ratio of the total display size to the size of the display area exceeds a threshold.

15. The non-transitory computer-readable storage medium according to claim 14, wherein the process further comprising:
obtaining display status-related information including a resolution of a monitor for displaying the display area, and a display size of the selection area per file; and
calculating the ratio, based on the obtained display status-related information.

16. The non-transitory computer-readable storage medium according to claim 14, wherein the process further comprising:
obtaining display status-related information including a window size of the display area, information about an arrangement of the selection areas in the display area, and a display size of the selection area per file; and
calculating the ratio, based on the obtained display status-related information.

17. The non-transitory computer-readable storage medium according to claim 16, wherein the outputting of the alert is performed based on whether the display area is scrollable or not.

18. The non-transitory computer-readable storage medium according to claim 14, wherein the outputting of the alert is performed when a time duration from when the operation-target file is selected until when the operation-target file is operated, is shorter than a time threshold.

19. The non-transitory computer-readable storage medium according to claim 14, wherein the outputting of the alert is performed in response to a selection of the operation-target file, or an operation on the operation-target file.

20. A method of checking a file operation, the method comprising:
detecting a size of a display area for displaying respective selection areas associated with a plurality of selection candidate files that are selectable as an operation-target file, and a total display size of the selection areas for the selection candidate files displayed on the display area; and
outputting an alert for prompting a confirmation of the file selected as the operation-target file, when a ratio of the total display size to the size of the display area exceeds a threshold.
